(19) United States
(12) Patent Application Publication
(10) Pub. No.: US 2023/0342527 A1
(43) Pub. Date: Oct. 26, 2023

(54) METHOD OF CIRCUIT SIMULATION, TEST APPARATUS, ELECTRONIC DEVICE, AND MEDIUM

(71) Applicant: CHANGXIN MEMORY TECHNOLOGIES, INC., Hefei City (CN)

(72) Inventors: Yu LI, Hefei City (CN); Teng SHI, Hefei City (CN)

(21) Appl. No.: 17/812,743

(22) Filed: Jul. 15, 2022

Related U.S. Application Data
(63) Continuation of application No. PCT/CN2022/097463, filed on Jun. 7, 2022.

(30) Foreign Application Priority Data
Apr. 24, 2022 (CN) 202210434613.0

(51) Int. Cl. G06F 30/3308

(52) U.S. Cl. CPC G06F 30/3308; G06F 2119/02

(57) ABSTRACT

The present disclosure provides a method of circuit simulation, a test apparatus, an electronic device, and a medium. The method includes: initializing a simulation environment, including selecting N memory cells from a memory array as to-be-verified cells, and performing repair verification on each to-be-verified cell; simulating the circuit, where the circuit includes an array region circuit and a peripheral region circuit; and outputting a circuit simulation result file, the circuit simulation result file including a result of repair verification for each to-be-verified cell.

### CROSS-REFERENCE TO RELATED APPLICATIONS

This is a continuation of International Application No. PCT/CN2022/097463, filed on Jun. 7, 2022, which claims the priority to Chinese Patent Application No. 202210434613.0, titled “METHOD OF CIRCUIT SIMULATION, TEST APPARATUS, ELECTRONIC DEVICE, AND MEDIUM” and filed with the China National Intellectual Property Administration (CNIPA) on Apr. 24, 2022. The entire contents of International Application No. PCT/CN2022/097463 and Chinese Patent Application No. 202210434613.0 are incorporated herein by reference.

### TECHNICAL FIELD

The present disclosure relates to memory technologies, and in particular, to a method of circuit simulation, a test apparatus, an electronic device, and a medium.

### BACKGROUND

With the development of the memory technology, memory is widely used, e.g., dynamic random access memory (DRAM). During the actual production and use of memory, a memory cell failure point may occur, where the memory cell failure point cannot work properly and needs to be repaired.

Therefore, it is necessary to consider how to verify repair of a memory cell effectively.

### SUMMARY

Embodiments of the present disclosure provide a method of circuit simulation, a test apparatus, an electronic device, and a medium.

According to some embodiments, a first aspect of the present disclosure provides a method of circuit simulation, where the circuit includes an array region circuit and a peripheral region circuit, and the method includes: initializing a simulation environment, including selecting N memory cells from a memory array as to-be-verified cells, and performing repair verification on each to-be-verified cell, where N is greater than or equal to 10 and less than or equal to 20; simulating the circuit; and outputting a circuit simulation result file, the circuit simulation result file including a result of repair verification for each to-be-verified cell.

According to some embodiments, a second aspect of the present disclosure provides a test apparatus, including: one or more processors; and a storage apparatus, configured to store one or more programs, wherein the one or more programs, when executed by the one or more processors, cause the one or more processors to execute operations of: initializing a simulation environment, including selecting N memory cells from a memory array as to-be-verified cells, and performing repair verification on each to-be-verified cell, where N is greater than or equal to 10 and less than or equal to 20; simulating a circuit, where the circuit includes an array region circuit and a peripheral region circuit; and outputting a circuit simulation result file, the circuit simulation result file including a result of repair verification for each to-be-verified cell.

According to some embodiments, a third aspect of the present disclosure provides a computer readable storage medium, where the computer readable storage medium stores computer executable instructions, and when executed by a processor, the computer executable instruction implements the method described above.

### BRIEF DESCRIPTION OF THE DRAWINGS

The accompanying drawings incorporated into the specification and constituting part of the specification illustrate the embodiments of the present disclosure, and serve, together with the specification, to explain the principles of the embodiments of the present disclosure.

FIG. 1 is a diagram of an example of architecture of a memory according to an embodiment of the present disclosure;

FIG. 2 is a diagram of an example of a memory cell according to an embodiment of the present disclosure;

FIG. 3 is an architecture diagram of circuit simulation in an example;

FIG. 4 is a schematic flowchart of a method of circuit simulation according to an embodiment;

FIG. 5 is an architecture diagram of circuit simulation according to an embodiment;

FIG. 6 is a memory array in an example;

FIG. 7 is a diagram of an example of distribution of to-be-verified cells in a single circuit simulation;

FIG. 8 is a diagram of an example of an initial state in FIG. 7;

FIG. 9 is a schematic flowchart of a method of circuit simulation according to an embodiment;

FIG. 10 is a schematic structural diagram of a test apparatus according to an embodiment; and

FIG. 11 is a schematic structural diagram of an electronic device according to an embodiment of the present disclosure.

Specific embodiments of the present application are shown by using the accompanying drawings and are described below in more detail. The accompanying drawings and text description are not intended to limit the scope of the concept of the present application in any manner, but to explain the concept of the present application for those skilled in the art with reference to specific embodiments.

### DETAILED DESCRIPTION

Exemplary embodiments are described in detail herein, and examples thereof are represented in the accompanying drawings. When the following descriptions relate to the accompanying drawings, unless otherwise stated, same numerals in different accompanying drawings represent same or similar elements. Implementations described in the following exemplary embodiments do not represent all implementations consistent with the present disclosure. On the contrary, the implementations are merely examples of apparatuses and methods that are described in detail in the appended claims and consistent with some aspects of the present disclosure.

The terms “includes” and “has” in the present disclosure are used to indicate an open-ended inclusion and to mean that additional elements/components/and the like may exist in addition to the listed elements/components/and the like. The terms “first”, “second”, and the like are merely used as markers, not as quantitative restrictions on objects thereof. In addition, the different elements and regions in the accompanying drawings are shown schematically only, and therefore the present disclosure is not limited to the sizes or distances shown in the accompanying drawings.

The technical solution of the present disclosure will be described in detail below with reference to specific embodiments. The following specific embodiments may be combined with each other, and the same or similar concepts or processes may not be repeatedly described in some embodiments. The embodiments of the present disclosure will be described in detail below with reference to the drawings.

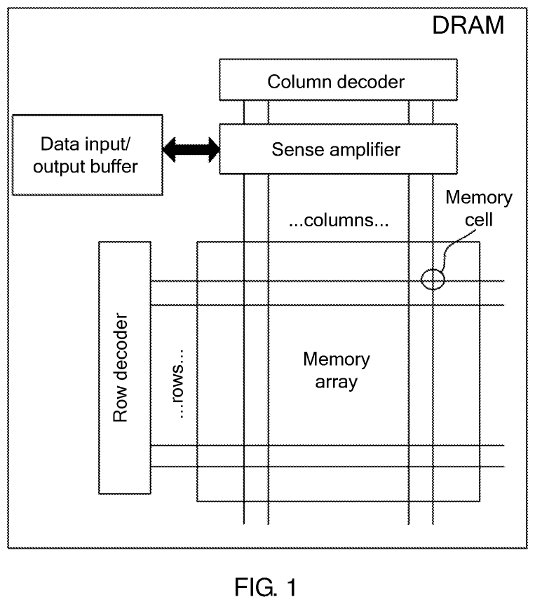

FIG. 1 is a diagram of an example of architecture of a memory according to an embodiment of the present disclosure. As shown in FIG. 1, using a DRAM as an example, the memory includes a data input/output buffer, a row decoder, a column decoder, a sense amplifier, and a memory array. The data input/output buffer belongs to a peripheral region circuit; the sense amplifier, the row decoder, the column decoder, and the memory array belong to an array region circuit. The memory array mainly consists of rows and columns. Intersections between the rows along a row direction of the array and bit lines are memory cells of the memory array.

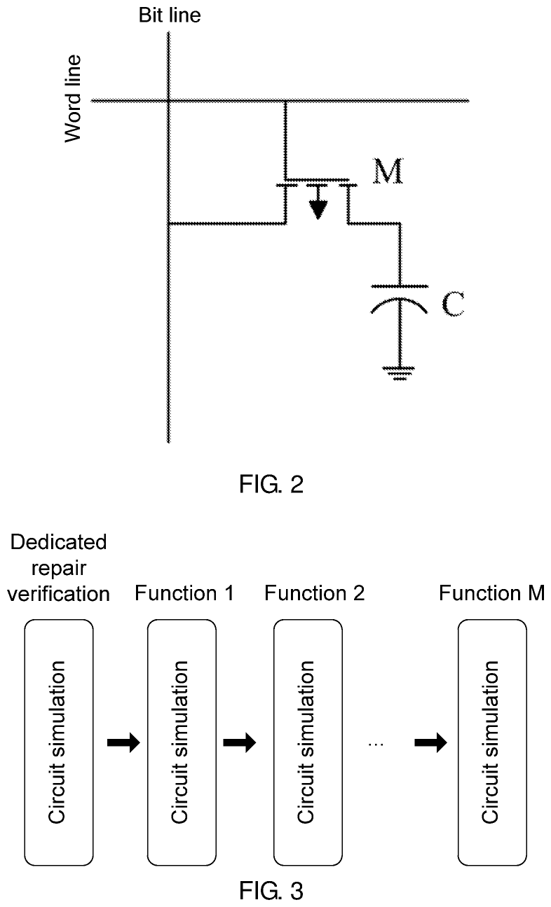

Each memory cell is configured to store data of one bit. FIG. 2 is a diagram of an example of a memory cell according to an embodiment of the present disclosure. As shown in FIG. 2, the memory cell mainly consists of a transistor switch M and a capacitor C. The capacitor is configured to store bit data, and the transistor switch is configured to turn off or on according to a selected state.

A certain memory cell is activated by controlling a row and a column, to implement access to the memory cell. Taking a reading scenario as an example, when bit data in a memory cell needs to be read, a row (word line) in which the memory cell is located may be selected by the row decoder. Correspondingly, the transistor switch M shown in the figure is turned on, and a state of the capacitor C can be sensed in this case through sense amplification for a column (bit line) signal. For example, if the bit data stored in the memory cell is 1, 1 is read from the bit line of the memory cell after the transistor switch M is turned on, and vice versa. In addition, taking a writing scenario as an example, when bit data, such as 1, needs to be written into a certain memory cell, a row (word line) in which the memory cell is located may be selected by the row decoder. Correspondingly, the transistor switch M shown in the figure is turned on, and a logic level of the column (bit line) is set to 1, such that the capacitor C is charged, that is, 1 is written into the memory cell. On the contrary, if 0 needs to be written, the logic level of the bit line is set to 0, such that the capacitor C is discharged, that is, 0 is written into the memory cell.

In actual application, during production of the DRAM, memory cell failure points may occur. That is, a small portion of memory cells cannot work normally; or with inevitable aging and damage of the device, especially challenges in the operation environment (high-temperature environment) and frequent running of the memory, failed memory cells may occur in the memory array, i.e., memory cell failure points. Therefore, to prevent failure of some of the memory cells from affecting normal operation of the memory, regular is memory cells are planned as a regular part and spare memory cells are additionally planned as a redundant part during design, to implement repair of the memory cell failure points. In a memory cell repair solution, if it is found upon test that some regular memory cells have failure points, memory cells in the redundant part can be used for row address replacement. For example, an access address of a failure point is directed to a memory cell that operates normally of the redundant part. In this way, the failure point is no longer accessed in subsequent use, thereby ensuring normal operation of the entire memory.

Based on the description above, the designed memory has a memory cell repair function. Correspondingly, during test, the repair function needs to be verified. In an exemplary technology, FIG. 3 is an architecture diagram of circuit simulation in an example. As shown in FIG. 3, similar to simulation dedicated to other functions (such as reading/writing function), directional simulation verification is specifically established for the repair function of the circuit, that is, dedicated repair verification is used to verify the repair function of the circuit. Because the redundant part includes a large number of memory cells, the failure point repair solution based on address replacement has lots of possibilities, and it requires a lot of time to perform simulation verification of the memory cell repair function. It should be noted that, the figure only shows an example. The specific type and sequence of circuit simulation may be adjusted according to actual requirements, but are not limited to the form in the figure.

Some aspects of the embodiments of the present disclosure relate to the considerations above. Examples of the solution are described below with reference to some embodiments of the present disclosure.

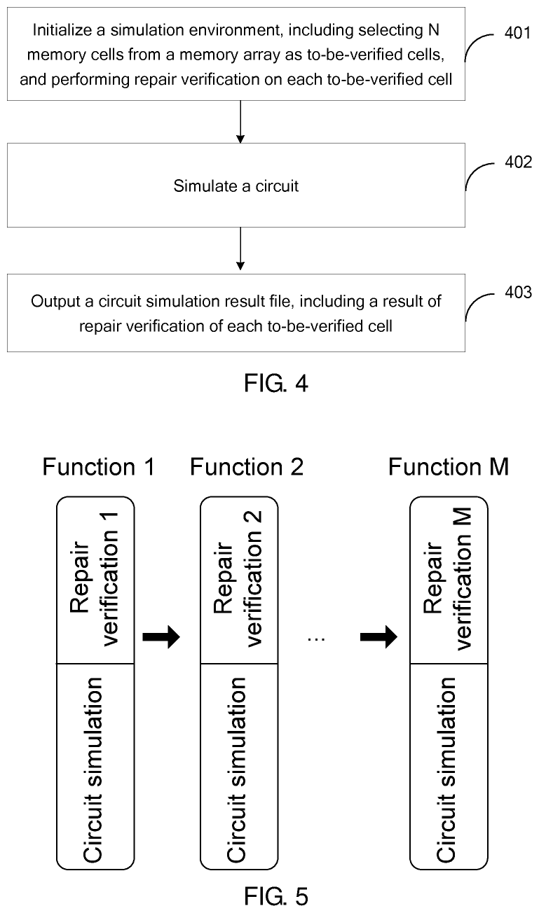

FIG. 4 is a schematic flowchart of a method of circuit simulation according to an embodiment. As shown in FIG. 4, the simulation of a circuit includes:

Step 401: Initialize a simulation environment, including selecting N memory cells from a memory array as to-be-verified cells, and performing repair verification on each to-be-verified cell.

Step 402: Simulate a circuit.

Step 403: Output a circuit simulation result file, including a result of repair verification for each to-be-verified cell.

In actual application, the method of circuit simulation provided by this embodiment may be applied to simulation of various memories. For example, the method of circuit simulation may be applied to simulation of a double data rate RAM (DDR). The circuit includes an array region circuit and a peripheral region circuit. N is a positive integer. In an example, N is greater than or equal to 10 and less than or equal to 20.

The circuit simulation refers to simulation verification for functions other than the repair function. For example, the circuit simulation includes, but is not limited to: simulation of functions such as a reading operation function, a writing operation function, a reading and writing operation function, a self-refresh function, a refresh function, ZQ calibration function, and a power-down pre-charge function. That is, in this embodiment, simulation verification of the repair function is used as a part of initialization of simulation of other functions, memory cells of the regular part and redundant part are selected each time to perform repair verification. In this way, it is unnecessary to run a huge amount of directional simulation to specifically verify the repair function; instead, each time simulation of another function is initialized, a certain portion of repair verification is implemented, such that repair verification of the entire memory array is gradually completed in multiple simulation processes of other functions, thereby improving the efficiency of repair verification.

With reference to a scenario example, FIG. 5 is an architecture diagram of circuit simulation according to an embodiment. In actual application, the principle of memory cell repair is mainly address replacement. However, due to a large number of memory cells of the regular part and the redundant part, the dedicated repair verification requires a long continuous period of time. In this embodiment, as shown in FIG. 5, in each initialization process of simulation of other functions (such as function 1 and function 2 in the figure), some memory cells are selected for repair verification (for example, repair verifications 1 to M are repair verifications during the initialization process of simulation of various functions), such that repair verification of the entire memory array is gradually completed in multiple simulation processes of other functions.

The number of to-be-verified cells in each repair verification may be determined according to actual situations. For example, the number of to-be-verified cells may be determined with reference to the number of simulation items. For example, if there are a lot of simulation items in the circuit test, a small number of memory cells may be selected during the initialization process of each simulation item to perform repair verification. Alternatively, the number of to-be-verified cells may be determined randomly. In an example, the number of to-be-verified cells, that is, N, may be generated randomly.

Referring to the example in FIG. 5, each circuit simulation (not the dedicated repair verification) process is basically as follows: if the current circuit simulation is used for verifying the function 1, circuit simulation of the function 1 is initialized first; specifically, in addition to initialization required for simulation of the function 1, in the simulation process, N memory cells are further selected from the memory array as to-be-verified cells, and repair verification for the N to-be-verified cells is implemented; after the initialization is completed, normal simulation of the function 1 is performed, and a circuit simulation result file of the function 1 is finally outputted. Compared with circuit simulation of the function 1, the simulation process herein differs in that the outputted circuit simulation result file further includes repair verification results of the N to-be-verified cells. Similarly, during the initialization process of the function 2, after repair verification is performed for some memory cells, circuit simulation of the function 2 is performed, and a simulation result including repair verification results of these memory cells is finally outputted. The repair verification is implemented in the multiple initialization processes of simulation, which improves the efficiency of repair simulation.

Referring to the example in FIG. 1, the memory cell can be located through an address, that is, determined through a row address and a column address of the memory cell. Therefore, to make it convenient to determine the current to-be-verified cell, to-be-verified cells that require repair verification currently may be determined according to some address information. Therefore, in some embodiments, the to-be-verified cell may be determined through an address. Correspondingly, in step 401, the selecting N memory cells as to-be-verified cells may specifically include:

receiving N pieces of address information, where the address information includes row address information and column address information of a memory cell, the row address information belongs to a row address information set of the memory array, and is the column address information belongs to a column address information set of the memory array; and

determining the to-be-verified cells according to the address information.

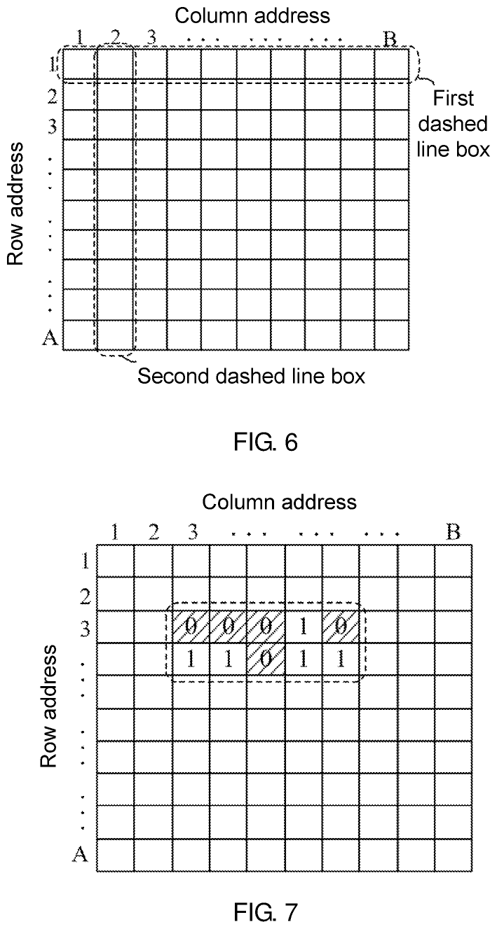

The N pieces of address information represent the N to-be-verified cells, and the N pieces of address information may be randomly specified. For example, N may be 10. With reference to the array arrangement characteristics of the memory array, in an example, the N pieces of address information may include a plurality of column addresses with a same row address. That is, memory cells located in a same row are selected as to-be-verified cells. For example, a plurality of memory cells with a row address 1 are selected; correspondingly, address information of these memory cells is <1, X>, where X may be filled with N different column addresses. In an optional implementation, under the same row address, the column addresses may be selected randomly. FIG. 6 is a memory array in an example. As shown in FIG. 6, the memory array is an A×B array (which is only an example in the figure), the first dashed line box shows N to-be-verified cells randomly selected under a certain row address (for example, row address 1). With reference to the situation shown in the figure, N is B herein.

In another example, the N pieces of address information may include a plurality of row addresses with a same column address. That is, memory cells in a same column are selected as to-be-verified cells. For example, a plurality of memory cells with a column address 2 are selected; correspondingly, address information of these memory cells is <Y, 2>, where Y may be filled with N different row addresses. Likewise, in an optional implementation, under the same column address, the row addresses may be selected randomly. Still referring to FIG. 6, the second dashed line box in FIG. 6 shows N to-be-verified cells randomly selected under a certain column address (for example, column address 2). With reference to the situation shown in the figure, N is A herein.

Through the foregoing selection manner of to-be-verified cells, the memory array can be reliably traversed based on the arrangement characteristics of the memory array, to perform repair verification. In actual application, different random modes may be set based on different selection manners of to-be-verified cells. For example, in an implementation combining the two examples above, a selection manner with a same row address and random column addresses may be set as a first random mode, and a selection manner with a same column address and random row addresses is set to a second random mode. Subsequently, during repair verification based on circuit simulation, a traversing manner of the repair verification can be conveniently determined by selecting the first random mode or second random mode.

The manner of repair verification of the to-be-verified cell is not limited. In some embodiments, in step 401, the performing repair verification on each to-be-verified cell specifically includes:

performing repair replacement on the to-be-verified cell by using a repair circuit; writing first data into an address corresponding to the to-be-verified cell after repair replacement; and

reading the address corresponding to the to-be-verified cell after repair replacement, and if currently read data is the first data, determining that repair of the to-be-verified cell succeeds.

The principle of the repair circuit is mainly address replacement, and the implementation structure thereof is not limited. For details, reference may be made to the related art. In an example, the performing repair replacement on the to-be-verified cell by using a repair circuit may specifically include:

randomly selecting a redundant memory cell; and

replacing an address of the to-be-verified cell with an address of the redundant memory cell, to complete repair replacement for the to-be-verified cell.

In this example, the redundant memory cell is randomly selected by using the repair circuit, and the address of the to-be-verified cell is replaced with the address of the redundant memory cell, which can conveniently complete repair replacement of the to-be-verified cell, to facilitate subsequent verification of whether repair succeeds or not.

In the foregoing embodiment, to perform repair verification on the to-be-verified cell, the repair circuit may first perform repair replacement for the to-be-verified cell, i.e., the address of the to-be-verified cell is replaced with an address of a certain redundant memory cell. In subsequent operation of the memory, if the to-be-verified cell can be successfully replaced with the redundant memory cell, the repair succeeds. In other is words, if the address corresponding to the to-be-verified cell repair replacement can realize normal reading and writing, it indicates that the to-be-verified memory cell is successfully repaired. In this example, first data is first written into the address corresponding to the to-be-verified cell after repair replacement, and then data under the address is read. If the read data is the previously written first data, it indicates that the address replacement succeeds, that is, the repair succeeds.

Based on the foregoing embodiment, in another case, after the reading the address corresponding to the to-be-verified cell after repair replacement, the method further includes:

if the currently read data is not the first data, determining that repair of the to-be-verified cell fails.

With reference to an actual scenario example, after a certain to-be-verified cell is repaired, the reading and writing function of the repaired cell may be verified. If the repaired cell has a normal reading and writing function, it indicates that the repair succeeds. In an example, after the to-be-verified cell is repaired, first data is written into the address after the repair. After the first data is written, data under the address is read.

If the read data is the first data, it indicates that the repaired cell can realize normal reading and writing, that is, the repair succeeds. On the contrary, after the first data is written, if the data read from the address is not the previously written first data, it indicates that the repaired cell cannot realize normal reading and writing, that is, the repair fails.

In the foregoing embodiment, by writing data into the address of the repaired to-be-verified cell and comparing whether data read from the replaced address is consistent with the written data, repair verification of the to-be-verified memory cell can be completed conveniently, which further simplifies the repair verification process during initialization of each circuit simulation, thereby further improving the efficiency of repair verification.

In addition, to further ensure the accuracy of repair verification, based on the foregoing embodiment, in an example, before the writing first data into an address corresponding to the to-be-verified cell after repair replacement, the method further includes:

reading the address; and

the writing first data into an address corresponding to the to-be-verified cell after repair replacement includes:

if currently read data is empty, writing the first data into the address corresponding to the to-be-verified cell after repair replacement.

With reference to a scenario example, in a repair process of a certain to-be-verified cell, a redundant memory cell is selected first, and repair replacement of the to-be-verified cell is performed based on the selected redundant memory cell. The specific process may be replacing an original address of the to-be-verified cell with an address of the redundant memory cell. Therefore, it may be understood that, if the repair succeeds, the address of the to-be-verified cell is replaced with the address of the redundant memory cell; correspondingly, data currently read from the address after the repair should be data stored at the replaced address. Therefore, in this example, after the to-be-verified cell is repaired, the address currently corresponding to the to-be-verified cell is read; if currently read data is empty, it indicates that the address replacement succeeds, and then subsequent repair verification is performed, for example, verification of whether the memory cell with the replaced address can realize reading and writing normally.

Based on the foregoing embodiment, in another case, after the reading the address, the method further includes:

if the currently read data is not empty, determining that repair of the to-be-verified cell fails and interrupting the process.

With reference to the foregoing scenario example, after the repair, an address currently corresponding to the repaired cell, i.e., the address, is read; if data read from the address is not empty, it indicates that the read address may still be the original address before repair, or the read address is at least not an idle redundant memory address, both indicating that the repair fails. In actual application, before a redundant memory cell (i.e., idle redundant memory address) is used for repairing a regular memory cell, data stored in the redundant memory cell is empty. To ensure the effectiveness of the repair, the repaired memory cell needs to meet the following requirement: the redundant memory cell used for repair replacement of the to-be-verified cell should not be alternative cells of other regular memory cells, that is, the selected redundant memory is cell should be a currently idle memory cell. In other words, one redundant memory cell cannot be used as repair replacement cells of a plurality of regular memory cells simultaneously, to ensure normal operation of the memory.

In the foregoing example, the address corresponding to the repaired to-be-verified cell is read. If read data is empty, subsequent repair verification is further performed, such that a repair error can be detected in time, thereby avoiding unnecessary subsequent processing, improving verification efficiency, and saving resources.

In actual application, to avoid that repair verification is performed on the same memory cell repeatedly, in some embodiments, after the selecting N memory cells from a memory array as to-be-verified cells in step 401 and before the performing repair verification on each to-be-verified cell in step 401, the method further includes:

writing second data into the to-be-verified cell, where the second data is different from the first data; and

Correspondingly, the performing repair verification on each to-be-verified cell in step 401 includes:

reading the to-be-verified cell; and

if currently read data is the second data, performing repair verification on the to-be-verified cell.

With reference to a scenario example, repair verification of the memory array is performed in separate batches. That is, in the initialization process of each circuit simulation, N memory cells are selected as to-be-verified cells for repair verification. For example, as shown in FIG. 7, FIG. 7 is a diagram of an example of distribution of to-be-verified cells in a single circuit simulation. After N to-be-verified cells are selected, repair verification is performed on each to-be-verified cell. As shown in FIG. 7, it is assumed that the memory cells in the dashed line box are the N to-be-verified cells selected in the current circuit simulation, and repair verification needs to be performed on each cell. In this case, the to-be-verified cell in each repair verification should not be a cell on which repair verification has been performed previously; otherwise, repair verification will be performed on a same memory cell repeatedly, affecting verification efficiency.

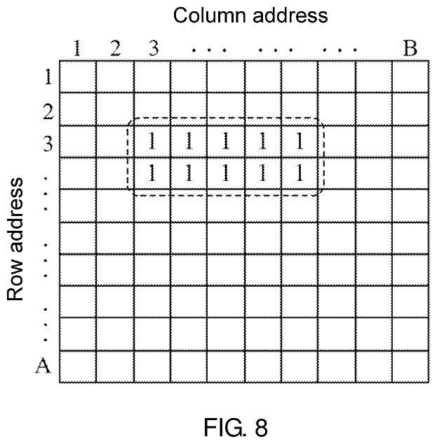

In view of the situation above, in this example, after the N to-be-verified cells are selected, second data (such as data 1) is first written into all the to-be-verified cells selected currently. For example, FIG. 8 is a diagram of an example of an initial state in FIG. 7, that is, after the to-be-verified cells shown in the figure are selected, 1 is written into all the to-be-verified cells. Afterwards, in the process of performing repair verification on each to-be-verified cell, other data such as the first data (e.g., data 0) may be written into the repaired cell. For details, reference may be made to the foregoing process about repair verification. The first data is different from the second data, for example, the first data and the second data have opposite logical states. On the basis of the method above, in the N to-be-verified cells, data read from the cell on which the repair verification has been performed is not the originally written second data, but the first data written during the repair verification process. With reference to the example in the figure, after repair verification for some of the to-be-verified cells, among the to-be-verified cells in the dashed line box, shaded cells store the first data such as 0, and non-shaded cells store the second data such as 1. In this case, the current to-be-verified cell is, for example, one of the non-shaded cells. That is, 1 is read from the current address of the to-be-verified cell, and then subsequent repair verification can be performed. If the current to-be-verified cell is one of the shaded cells, 0 is read from the current address of the to-be-verified cell; in this case, the cell is directly skipped, and a new cell is selected.

Based on this, before repair verification is performed on the currently determined to-be-verified cell, the to-be-verified cell is read first, and if the read data is the second data, it indicates that the to-be-verified cell has not been repaired, and subsequent repair verification can be performed. On the contrary, if the read data is the first data, it indicates that the to-be-verified cell has been repaired and can be directly skipped. In actual application, after the cell is skipped, another to-be-verified cell can be selected for repair verification. Therefore, in an example, after the reading the to-be-verified cell, the method further includes:

if the currently read data is not the second data, skipping repair verification for the to-be-verified cell.

In the foregoing embodiment, after the to-be-verified cells are selected, second data is written into all the to-be-verified cells. Before subsequent repair verification for each to-be-verified cell, it is first detected whether data read from the to-be-verified cell is the second data, to avoid repeated verification, thereby further improving the efficiency of repair verification.

In the method of circuit simulation provided by the embodiments of the present disclosure, in the process of circuit simulation, a simulation environment is initialized first, where the initialization includes selecting N memory cells and performing repair verification on these memory cells; circuit simulation is performed subsequently, and a finally outputted circuit simulation result file includes repair verification results of the memory cells. In the foregoing solution, repair verification of the memory array is split into repair verifications for a set of memory cells, and verification of each set of memory cells is performed in combination with circuit simulation, so that verification of all the memory cells, i.e., repair verification of the entire memory array, can be completed gradually during circuit simulation. The solution of the present disclosure can greatly reduce the overall time consumption and improve the efficiency of repair verification.

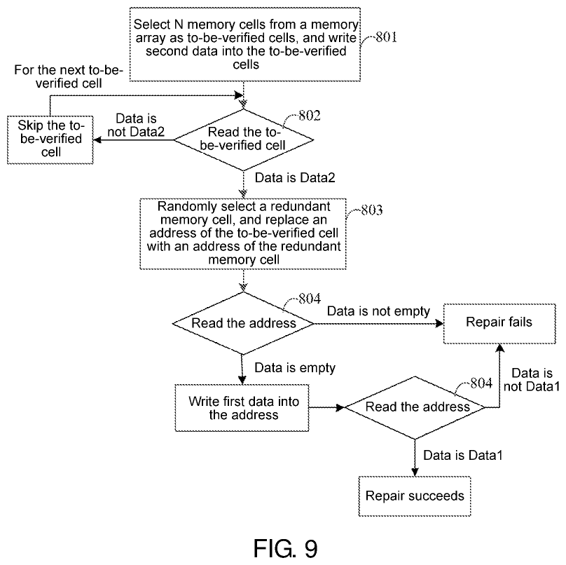

It should be noted that, the foregoing embodiments can be implemented separately or in combination. In some examples of combined implementation, FIG. 9 is a schematic flowchart of a method of circuit simulation according to an embodiment; as shown in FIG. 9, the repair verification process is mainly illustrated in the figure. For the process of circuit simulation, for example, initialization, circuit simulation and other steps, reference may be made to the content of the foregoing embodiment. Specifically, the method includes:

Step 801: Select N memory cells from a memory array as to-be-verified cells, and write second data (Data2) into the to-be-verified cells.

Step 802: Read the to-be-verified cell, and if currently read data is the second data, perform step 803; otherwise, skip the to-be-verified cell, and read the next to-be-verified cell.

Step 803: Randomly select a redundant memory cell, and replace an address of the to-be-verified cell with an address of the redundant memory cell.

Step 804: Read the address corresponding to the to-be-verified cell after repair replacement, and if currently read data is empty, perform step 805; otherwise, determine that repair of the to-be-verified cell fails.

Step 805: Write first data (Data1) into the address.

Step 806: Read the address, and if currently read data is the first data, determine that repair of the to-be-verified cell succeeds; otherwise, determine that repair of the to-be-verified cell fails.

In actual application, if it is determined that the repair fails, related circuit logic of the repair circuit may be checked, to timely resolve faults that lead to the repair failure.

In the method of circuit simulation provided by the embodiments of the present disclosure, in the process of circuit simulation, a simulation environment is initialized first, where the initialization includes selecting N memory cells and performing repair verification on these memory cells; circuit simulation is performed subsequently, and a finally outputted circuit simulation result file includes repair verification results of the memory cells. In the foregoing solution, repair verification of the memory array is split into multiple repair verifications for a set of memory cells, and verification of each set of memory cells is performed in combination with circuit simulation, so that verification of all the memory cells, i.e., repair verification of the entire memory array, can be completed gradually during circuit simulation. The solution of the present disclosure can greatly reduce the overall time consumption and improve the efficiency of repair verification.

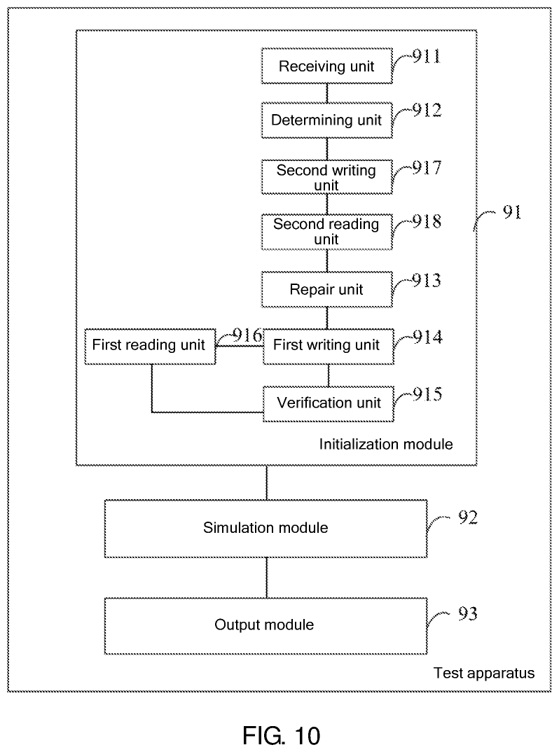

FIG. 10 is a schematic structural diagram of a test apparatus according to an embodiment. As shown in FIG. 10, the test apparatus includes:

an initialization module 91 configured to initialize a simulation environment, including: selecting N memory cells from a memory array as to-be-verified cells, and performing repair verification on each to-be-verified cell, where N is greater than or equal to 10 and less than or equal to 20;

a simulation module 92 configured to simulate a circuit, where the circuit includes an array region circuit and a peripheral region circuit; and

an output module 93 configured to output a circuit simulation result file, including a result of repair verification for each to-be-verified cell.

In actual application, the test apparatus provided by this embodiment may be applied to simulation of various memories. For example, the test apparatus may be applied to simulation of a double data rate RAM (DDR).

The circuit simulation refers to simulation verification for functions other than the repair function. For example, the circuit simulation includes, but is not limited to: simulation of functions such as a reading operation function, a writing operation function, a reading and writing operation function, a self-refresh function, a refresh function, ZQ calibration function, and a power-down pre-charge function.

In an example, the number of to-be-verified cells, that is, N, may be generated randomly.

In some embodiments, the to-be-verified cell may be determined through an address. Correspondingly, the initialization module 91 includes:

a receiving unit 911 configured to receive N pieces of address information, where the address information includes row address information and column address information of a memory cell, the row address information belongs to a row address information set of the memory array, and the column address information belongs to a column address information set of the memory array; and

a determining unit 912 configured to determine the to-be-verified cells according to the address information.

In an example, the N pieces of address information may include a plurality column addresses with a same row address. In another example, the N pieces of address information may include a plurality row addresses with a same column address.

In actual application, different random modes may be set based on different selection manners of to-be-verified cells. For example, a selection manner with a same row address and random column addresses may be set as a first random mode, and a selection manner with a same column address and random row addresses is set to a second random mode.

In some embodiments, the initialization module 91 further includes: a repair unit 913 configured to perform repair replacement on the to-be-verified cell by using a repair circuit;

a first writing unit 914 configured to write first data into an address corresponding to the to-be-verified cell after repair replacement; and

a verification unit 915 configured to read the address corresponding to the to-be-verified cell after repair replacement, and if currently read data is the first data, determine that repair of the to-be-verified cell succeeds.

Based on the above embodiment, in another case, the verification unit 915 is further configured to: after reading the address corresponding to the to-be-verified cell after repair replacement, determine that repair of the to-be-verified cell fails if the currently read data is not the first data.

In an example, the repair unit 913 is specifically configured to randomly select a redundant memory cell; and the repair unit 913 is specifically further configured to replace an address of the to-be-verified cell with an address of the redundant memory cell, to complete repair replacement for the to-be-verified cell.

In the foregoing embodiment, by writing data into the address of the repaired to-be-verified cell and comparing whether data read from the replaced address is consistent with the written data, repair verification of the to-be-verified memory cell can be completed conveniently, which further simplifies the repair verification process during initialization of each circuit simulation, thereby further improving the efficiency of repair verification.

In addition, to further ensure the accuracy of repair verification, based on the foregoing embodiment, in an example, the initialization module 91 further includes:

a first reading unit 916 configured to read the address before the first writing unit 914 writes the first data into the address corresponding to the to-be-verified cell after repair replacement; and

the first writing unit 914 is specifically configured to write the first data into the address corresponding to the to-be-verified cell after repair replacement, if data currently read by the first reading unit 916 is empty.

In some embodiments, in another case, the verification unit 915 is further configured to: after the first reading unit 916 reads the address, determine that repair of the to-be-verified cell fails and interrupt the process if the data currently read by the first reading unit 916 is not empty.

In the foregoing example, the address corresponding to the repaired to-be-verified cell is read. If read data is empty, subsequent repair verification is further performed, such that a repair error can be detected in time, thereby avoiding unnecessary subsequent is processing, improving verification efficiency, and saving resources.

In actual application, to avoid that repair verification is performed on a same memory cell repeatedly, in some embodiments, the initialization module 91 further includes:

a second writing unit 917 configured to write second data into the to-be-verified cell after the initialization module 91 selects the N memory cells from the memory array as the to-be-verified cells and before repair verification is performed on each to-be-verified cell, where the second data is different from the first data; and

a second reading unit 918 configured to read the to-be-verified cell;

where the initialization module 91 is specifically configured to perform repair verification on the to-be-verified cell if data currently read by the second reading unit 918 is the second data.

In an example, the initialization module 91 is further configured to: after the second reading unit 918 reads the to-be-verified cell, skip repair verification for the to-be-verified cell if the data currently read by the second reading unit is not the second data.

In the foregoing embodiment, after the to-be-verified cells are selected, second data is written into all the to-be-verified cells. Before subsequent repair verification for each to-be-verified cell, it is first detected whether data read from the to-be-verified cell is the second data, to avoid repeated verification, thereby further improving the efficiency of repair verification.

In the test apparatus provided by the embodiments of the present disclosure, in the process of circuit simulation, a simulation environment is initialized first, where the initialization includes selecting N memory cells and performing repair verification on these memory cells; circuit simulation is performed subsequently, and a finally outputted circuit simulation result file includes repair verification results of the memory cells. In the foregoing solution, repair verification of the memory array is split into multiple repair verifications for a set of memory cells, and verification of each set of memory cells is performed in combination with circuit simulation, so that verification of all the memory cells, i.e., repair verification of the entire memory array, can be completed gradually during circuit simulation. The solution of the present disclosure can greatly reduce the overall time consumption and improve the efficiency of repair verification.

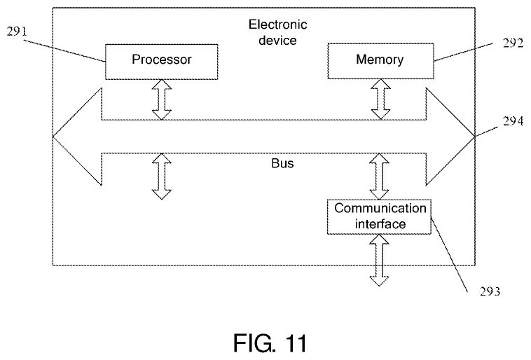

FIG. 11 is a schematic structural diagram of an electronic device according to an embodiment of the present disclosure. As shown in FIG. 11, the electronic device includes:

a processor 291 and a memory 292, where the electronic device may further include a communication interface 293 and a bus 294. The processor 291, the memory 292, and the communication interface 293 may communicate with each other through the bus 294. The communication interface 293 may be configured to transmit information. The processor 291 may invoke logic instructions in the memory 292, to execute the method of the foregoing embodiment.

In addition, the logic instructions in the memory 292, when implemented in the form of a software functional unit and sold or used as a stand-alone product, may be stored in a computer readable storage medium.

The memory 292, as a computer readable storage medium, may be configured to store a software program and a computer executable program, such as program instructions and modules corresponding to the method in the embodiments of the present disclosure. By running the software program, instructions and modules stored in the memory 292, the processor 291 performs functional application and data processing, thereby implementing the method in the foregoing method embodiment.

The memory 292 may include a program storage region and a data storage region. The program storage region may store an operating system, and an application program required by at least one function; the data storage region may store data that is created according to usage of a terminal device. In addition, the memory 292 may include a high-speed random access memory, and may further include a non-volatile memory.

The embodiments of the present disclosure further provide a computer-readable storage medium. The computer-readable storage medium stores computer executable instructions. The computer executable instructions are executed by a processor to implement the method described in any one of Embodiment 1 to Embodiment 4. Specific implementations and technical effects are similar, and details are not described herein again.

The present disclosure is described with reference to the flowcharts and/or block diagrams of the method, the apparatus (device), and the computer program product according to the embodiments of the present disclosure. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of any other programmable data processing device to generate a machine, such that the instructions executed by a computer or a processor of any other programmable data processing device generate an apparatus for implementing a specific function in one or more processes in the flowcharts and/or in one or more blocks in the block diagrams.

These computer program instructions may also be stored in a computer readable memory that can instruct the computer or any other programmable data processing device to work in a specific manner, such that the instructions stored in the computer readable memory generate an artifact that includes an instruction apparatus. The instruction apparatus implements a specific function in one or more processes in the flowcharts and/or in one or more blocks in the block diagrams.

These computer program instructions may also be loaded onto a computer or another programmable data processing device, such that a series of operations and steps are performed on the computer or the another programmable device, thereby generating computer-implemented processing. Therefore, the instructions executed on the computer or the another programmable device provide steps for implementing a function specified in one or more processes in the flowcharts and/or in one or more blocks in the block diagrams.

Those skilled in the art may easily figure out other implementation solutions of the present disclosure after considering the specification and practicing the application disclosed herein. The present disclosure is intended to cover any variations, purposes or applicable changes of the present disclosure. Such variations, purposes or applicable changes follow the general principle of the present disclosure and include common knowledge or conventional technical means in the technical field which is not disclosed in the present disclosure. The specification and embodiments are merely considered as illustrative, and the real scope and spirit of the present disclosure are pointed out by the appended claims.

It should be noted that the present disclosure is not limited to the precise structures described above and shown in the accompanying drawings, and can be modified and changed in many ways without departing from the scope of the present disclosure. The scope of the present disclosure is defined by the appended claims.

1. A method of circuit simulation, wherein a circuit comprises an array region circuit and a peripheral region circuit, and the method comprises:
initializing a simulation environment, comprising selecting N memory cells from a memory array as to-be-verified cells, and performing repair verification on each to-be-verified cell, wherein N is greater than or equal to 10 and less than or equal to 20;
simulating the circuit; and
outputting a circuit simulation result file, the circuit simulation result file comprising a result of repair verification for each to-be-verified cell.

2. The method according to claim 1, wherein the selecting N memory cells as to-be-verified cells comprises:
receiving N pieces of address information, wherein the address information comprises row address information and column address information of a memory cell, the row address information belongs to a row address information set of the memory array, and the column address information belongs to a column address information set of the memory array; and
determining the to-be-verified cells according to the address information.

3. The method according to claim 1, wherein the performing repair verification on each to-be-verified cell comprises:
performing repair replacement on the to-be-verified cell by using a repair circuit;
writing first data into an address corresponding to the to-be-verified cell after repair replacement; and
reading the address corresponding to the to-be-verified cell after repair replacement, and when currently read data is the first data, determining that repair of the to-be-verified cell succeeds.

4. The method according to claim 3, wherein the performing repair replacement on the to-be-verified cell by using a repair circuit comprises:
randomly selecting a redundant memory cell; and
replacing an address of the to-be-verified cell with an address of the redundant memory cell, to complete repair replacement for the to-be-verified cell.

5. The method according to claim 3, wherein before the writing first data into an address corresponding to the to-be-verified cell after repair replacement, the method further comprises:
reading the address; and
the writing first data into an address corresponding to the to-be-verified cell after repair replacement comprises:
when currently read data is empty, writing the first data into the address corresponding to the to-be-verified cell after repair replacement.

6. The method according to claim 5, wherein after the reading the address, the method further comprises:
when the currently read data is not empty, determining that repair of the to-be-verified cell fails and interrupting the process.

7. The method according to claim 3, wherein after the selecting N memory cells from a memory array as to-be-verified cells and before the performing repair verification on each to-be-verified cell, the method further comprises:
writing second data into the to-be-verified cell, wherein the second data is different from the first data; and
the performing repair verification on each to-be-verified cell comprises:
reading the to-be-verified cell; and
when currently read data is the second data, performing repair verification on the to-be-verified cell.

8. The method according to claim 7, wherein after the reading the to-be-verified cell, the method further comprises:
when the currently read data is not the second data, skipping repair verification for the to-be-verified cell.

9. The method according to claim 3, wherein after the reading the address corresponding to the to-be-verified cell after repair replacement, the method further comprises:
when the currently read data is not the first data, determining that repair of the to-be-verified cell fails.

10. A test apparatus, comprising:
one or more processors; and
a storage apparatus, configured to store one or more programs, wherein the one or more programs, when executed by the one or more processors, cause the one or more processors to execute operations of:
initializing a simulation environment, comprising: selecting N memory cells from a memory array as to-be-verified cells, and performing repair verification on each to-be-verified cell, wherein N is greater than or equal to 10 and less than or equal to 20;
simulating a circuit, wherein the circuit comprises an array region circuit and a peripheral region circuit; and
outputting a circuit simulation result file, the circuit simulation result file comprising a result of repair verification for each to-be-verified cell.

11. The test apparatus according to claim 10, wherein the selecting N memory cells as to-be-verified cells comprises:
receiving N pieces of address information, wherein the address information comprises a row address information and a column address information of a memory cell, the row address information belongs to a row address information set of the memory array, and the column address information belongs to a column address information set of the memory array; and
determining the to-be-verified cells according to the address information.

12. The test apparatus according to claim 10, wherein the performing repair verification on each to-be-verified cell comprises:
performing repair replacement on the to-be-verified cell by using a repair circuit;
writing first data into an address corresponding to the to-be-verified cell after repair replacement; and
reading the address corresponding to the to-be-verified cell after repair replacement, and when currently read data is the first data, determining that repair of the to-be-verified cell succeeds.

13. The test apparatus according to claim 12, wherein the performing repair replacement on the to-be-verified cell by using a repair circuit comprises randomly selecting a redundant memory cell; and
replacing an address of the to-be-verified cell with an address of the redundant memory cell, to complete repair replacement for the to-be-verified cell.

14. The test apparatus according to claim 12, wherein before the writing first data into an address corresponding to the to-be-verified cell after repair replacement, the one or more programs cause the one or more processors to execute operations of:
reading the address; and
the writing first data into an address corresponding to the to-be-verified cell after repair replacement comprises:
writing the first data into the address corresponding to the to-be-verified cell after repair replacement, when currently read data is empty.

15. The test apparatus according to claim 14, wherein the one or more programs cause the one or more processors to execute operations of: after the address is read, determining that repair of the to-be-verified cell fails and interrupting the process when the currently read data is not empty.

16. The test apparatus according to claim 12, wherein after the selecting N memory cells from a memory array as to-be-verified cells and before the performing repair verification on each to-be-verified cell, the one or more programs cause the one or more processors to execute operations of:
writing second data into the to-be-verified cell, wherein the second data is different from the first data; and
the performing repair verification on each to-be-verified cell comprises:
reading the to-be-verified cell; and
performing repair verification on the to-be-verified cell when currently read data is the second data.

17. The test apparatus according to claim 16, wherein the one or more programs cause the one or more processors to execute operations of: after the to-be-verified cell is read, skipping repair verification for the to-be-verified cell when the currently read data is not the second data.

18. The test apparatus according to claim 12, wherein the one or more programs cause the one or more processors to execute operations of: after the address corresponding to the to-be-verified cell after repair replacement is read, determining that repair of the to-be-verified cell fails when the currently read data is not the first data.

19. A computer readable storage medium, wherein the computer readable storage medium stores computer executable instructions, and the computer executable instructions are executed by a processor to implement the method according to claim 1.
